(19) United States
(12) Patent Application Publication
(10) Pub. No.: US 2014/0313459 A1
(43) Pub. Date: Oct. 23, 2014

(54) LIGHT BOX FOR BACKLIGHT OF AN LCD MONITOR

(71) Applicant: WAVIEN, INC., VALENCIA, CA (US)

(72) Inventor: KENNETH K. LI, CASTAIC, CA (US)

(73) Assignee: WAVIEN, INC., VALENCIA, CA (US)

(21) Appl. No.: 14/255,192

(22) Filed: Apr. 17, 2014

Related U.S. Application Data
(60) Provisional application No. 61/813,816, filed on Apr. 19, 2013.

(51) Int. Cl. G02F 1/13363; G02F 1/1335

(52) U.S. Cl. CPC G02F 1/13363; G02F 1/133603; G02F 2001/133638
USPC 349/69; 362/19

(57) ABSTRACT

An LCD monitor comprises an LCD panel and a backlight for providing illumination to the LCD panel. The backlight includes a light box having a reflective bottom and sides and an open top for allowing light to flow outwardly toward the LCD panel. The light box includes a light source preferably comprising a plurality of LED elements for generating light either from said edge or from said bottom, or from both said bottom and said edge. The light box further preferably comprises a plurality of wave plates interspersed with the LED elements for intercepting light and changing the polarity of such intercepted light. Preferably, the backlight includes a polarizer for transmitting light from the light box of a first polarization towards the LCD panel and reflecting light of a second polarization back towards the light box. At least some of the reflected light of the second polarization passes through the wave plates, is converted to the first polarization, and is reflected back towards said polarizer. Thus, the wave plates act as secondary light sources and assist in producing a uniform light output.

### CROSS-REFERENCE TO RELATED APPLICATIONS

The present application claims priority on U.S. provisional patent application No. 61/813,816, filed on Apr. 19, 2013.

### BACKGROUND OF THE INVENTION

LCD display monitors are used in a number of commercial applications, including televisions, computer monitors, tablets, laptops, smart phones, and signage. They have the advantage of being thin, relatively lightweight, and affordable.

FIG. 1 shows a typical LCD display. An LCD panel 10 is sandwiched between an input polarizer 12 and an output polarizer 14. A light box or light guide 16, which is also shown in FIG. 2, provides a source of back light, which passes through a diffuser 18 and a prismatic layer 20 before reaching the input polarizer 12. Typically, the diffuser 18, prismatic layer 20, and polarizers 12 and 14 are each a thin film layer.

The light source may be provided by illuminating one or more of the side edges of the light box 16 or by illuminating the back face of the light box 16. Typically, the source of the illumination is a plurality of LEDs, although other light sources may be employed.

The walls of the light box 16 can be perfect reflectors or partly diffusive reflectors. As shown in FIG. 1, the diffused light passes through the prismatic layers 20, producing a more collimated light, towards the LCD panel 10, with high angle light reflected back to the diffuser. Part of this reflected light will be scattered and redirected towards the output.

The light output from the prismatic layers 20 is polarized by the input polarizer 12 and passed to the LCD panel 10. Depending on the signal to the LCD panel 10, the polarization is modified for each pixel and sent to the output polarizer 14, creating a controlled output. The combination of the output from all of the pixels create the desired screen image. The unused polarized light, which is reflected back from the input polarizer 12, will scatter and eventually find its way back towards the LCD panel again, being recycled in the process.

FIGS. 3a and 3b illustrate a typical light box 16 which utilizes edge illumination. Typically, multiple LEDs 30 are positioned along one or more side walls 32 of the light box 16, which may be solid or hollow, and oriented so that output of the LEDs 30 is directed into the interior of the light box 16. The light box acts as a wave guide, with a portion of the input light escaping from the top, which is directed towards the LCD panel 10. The remainder of the light will reflect back and forth within the light box 16, creating a more uniform intensity profile for the LCD panel.

FIG. 4 shows an example of a known light box 16 with multiple LEDs 30 placed at predetermined locations and spacing on the back panel 17 (i.e., the panel facing towards the LCD panel 10) of the light box 16. The light box 16, and the LED number and spacing, are designed to provide sufficient intensity and a uniform back light for the LCD panel 10.

In the past, the light output of LEDs was typically low. In order to provide a uniform intensity profile for the LCD panel, the LEDs were spaced relatively close together, meaning that a large number of LEDs were used, which increased the complexity and cost of the light box 16. As the output of LEDs improved, the number of LEDs required to illuminate an LCD panel 10 has decreased. However, reducing the number of LEDs used as inputs to a light box 16 makes it more difficult for the light box to deliver a uniform backlighting for the LCD panel 10.

### SUMMARY OF THE INVENTION

The present invention is a light box for use in a display, preferably an LCD display monitor, which allows a smaller number of LEDs to be used, while providing a uniform backlight output, e.g., to the LCD panel. This is achieved by using one or more wave plates of predetermined size and shape which are secured on the inside reflective surface of the edge and/or bottom of the light box. Preferably, an array of wave plates are interspersed with the LEDs. The wave plates can be quarter wave plates or plates with other wave numbers. The wave plates can have any desired shape, such as square, rectangular, circles, etc.

In one embodiment of the invention, an LCD monitor comprises an LCD panel and a backlight for providing illumination to the LCD panel. The backlight includes a light box having a reflective bottom and sides and an open top for allowing light to flow outwardly toward the LCD panel. The light box includes a light source preferably comprising an array of LED elements for generating light either from said edge or from said bottom, or from both said bottom and the edge. The light box further preferably comprises a plurality of wave plates interspersed with the LED elements for intercepting light and changing the polarity of such intercepted light. Preferably, the backlight includes a polarizer for transmitting light from the light box of a first polarization towards the LCD panel and reflecting light of a second polarization back towards the light box. At least some of the reflected light of the second polarization passes through the wave plates, is converted to the first polarization, and is reflected back towards said polarizer. Thus, the wave plates act as secondary light sources.

In an alternative embodiment, the invention comprises a light box as described above which may be used as part of a backlight, e.g., for an LCD or other type of monitor.

### BRIEF DESCRIPTION OF THE DRAWINGS

FIG. 1 is a schematic side view of a known LCD monitor;

FIG. 2 is a schematic, perspective view of a light box for use in the monitor of FIG. 1;

FIGS. 3a and 3b are a schematic side and top views, respectively, of a light box for use in the LCD monitor of FIG. 1;

FIG. 4 is a schematic bottom view of another light box for use in the monitor of FIG. 1;

FIG. 5 is a schematic bottom view of a light box according to the invention;

FIG. 6 is a schematic bottom view of another embodiment of a light box according to the invention;

FIG. 7 is a schematic bottom view of a third embodiment of a light box according to the invention; and

FIG. 8 is a schematic bottom view of a fourth embodiment of a light box according to the invention.

### DETAILED DESCRIPTION OF THE INVENTION

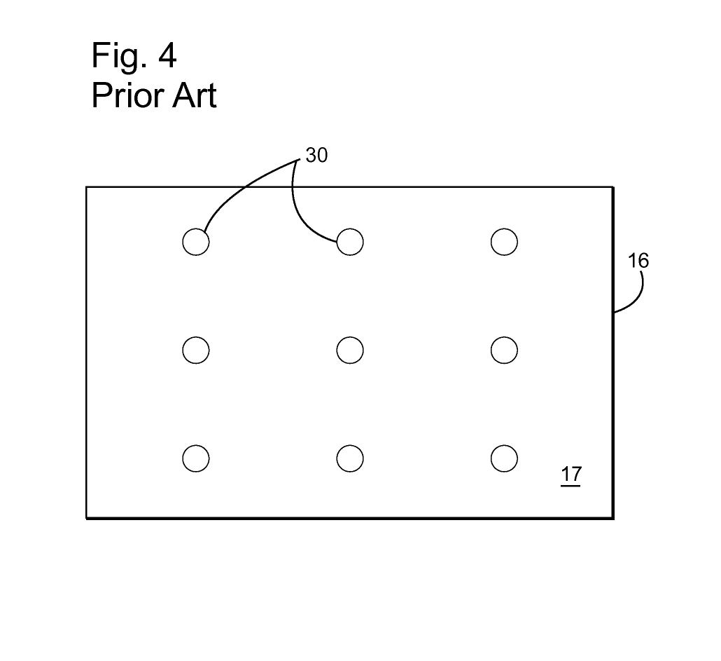

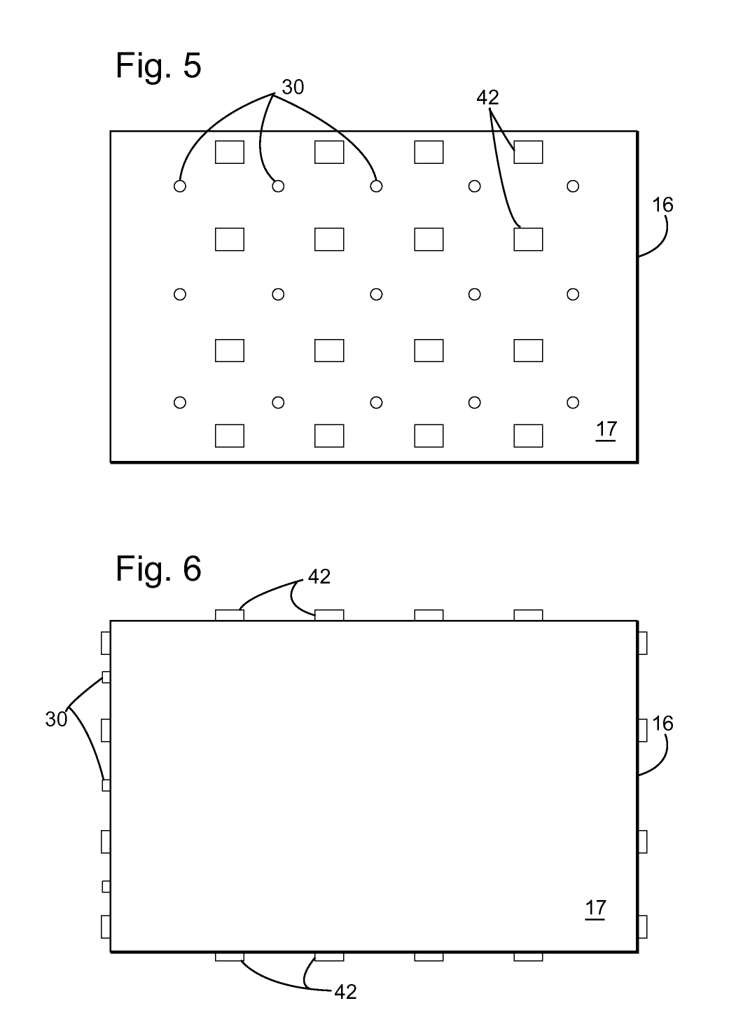

FIG. 5 shows a first embodiment of a light box 16 which includes a plurality of LEDs 30 secured to the bottom panel 17 of the light box 16. The interior surface of the bottom panel 17 may be a reflective or partly diffusive reflector. A plurality of wave plates 42 are interspersed with the LEDs. In the particular example shown in FIG. 4, three rows of LEDs 30, each row containing five LEDs, and four rows of wave plates 42, each row containing four wave plates 42 are provided. Except along the left and right edges, each LED is surrounded by four, equally spaced wave plates 42. Such array is merely exemplary, and other arrays may be employed.

As noted above, with the light box 16, a portion of the incoming light escapes towards the LCD panel 16, and part of such light, which does not have the desired polarization, is reflected back towards the light box 16. As a result, there is more than one type of polarization present. Moreover, the intensity of the reflected light having a polarization “A” in the light box 16 will be stronger than the light which passes through the polarizers 12, 14 (polarization “B”).

In the embodiment of FIG. 5, the wave plates 42 are quarter wave plates. When light having the polarization “A” is reflected back into the light box 16, at least some of the reflected light will be incident upon the wave plates 42, changing its polarization. As a result, light reflected by the wave plates 42, upon again traveling towards the LCD panel 10, this time will be allowed to pass through the LCD panel 10 and polarizers 12, 14. The net effect is that the quarter wave plates 42 act as secondary light sources, emitting light with the desired polarity. Moreover, the quarter wave plates 42 at the bottom of the light box 16 together with the LEDs 30 provide a smaller spacing between light sources, improving the uniformity of the back light, without increasing the number of LEDs 30 used.

FIG. 6 shows the bottom panel 17 of a light box 16 with edge illumination. Accordingly, a plurality of LEDs 30 and a plurality of wave plates 42 are mounted on the side walls of the light box 16. In the example, the wave plates 42 are mounted on opposed side walls, and the LEDs 30 are mounted on the other opposed side walls. However, LEDs 30 and wave plates 42 may be interspersed with one another. Moreover, the LEDs 30 and wave plates 42 may be mounted on only one side wall, on one pair of opposed sidewalls.

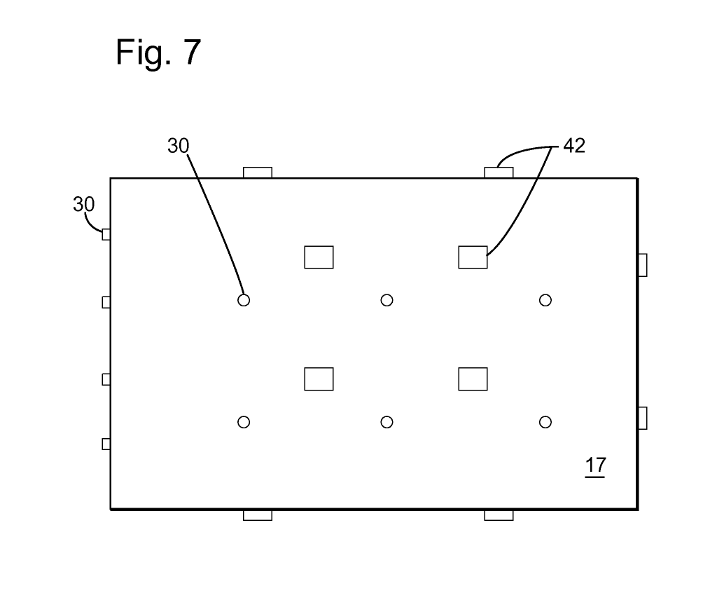

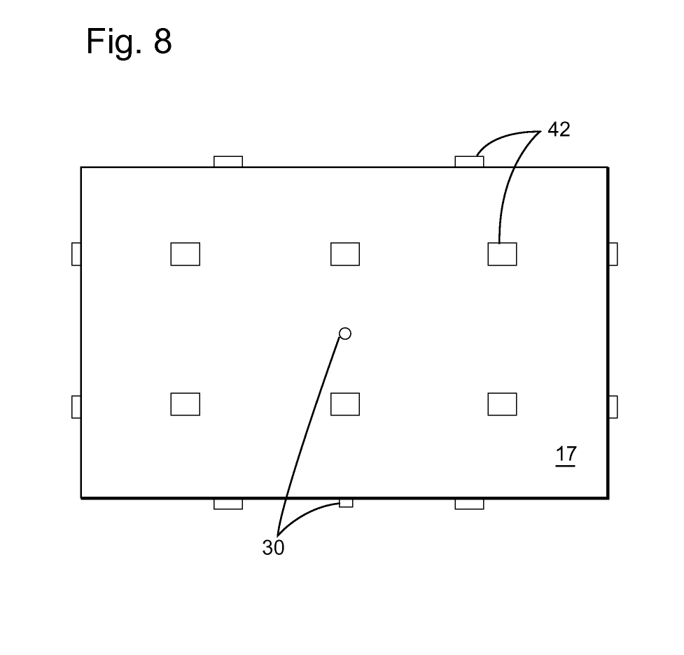

FIG. 7 shows a light box 16 in which LEDs 30 and wave plates 42 are mounted both along the edges and to the bottom panel 17. FIG. 8 shows another configuration of a light box 16 with a single LED 30, which may be mounted either along an edge or on the bottom panel 17. A plurality of wave plates 42 are mounted on either the edges or bottom panel 17, or both, of the light box 16. As in the other embodiments, the bottom panel 17 and edges of the light box 16 have an interior surfaces which are reflective or partially diffusive reflection.

The LEDs 30 and wave plates 42 can be positioned with a uniform spacing between them. Alternatively, the spacing can be non-uniform and even random as needed to provide a light intensity profile to the LCD panel 10 which is uniform.

The LEDs can be white LEDs used with LCD panels with color pixels. The LEDs may also be colored, with repeated red, green, and blue, and optional yellow. In an alternative embodiment, the LEDs can be LED arrays, with red, green, and blue, and optionally yellow, clustered together.

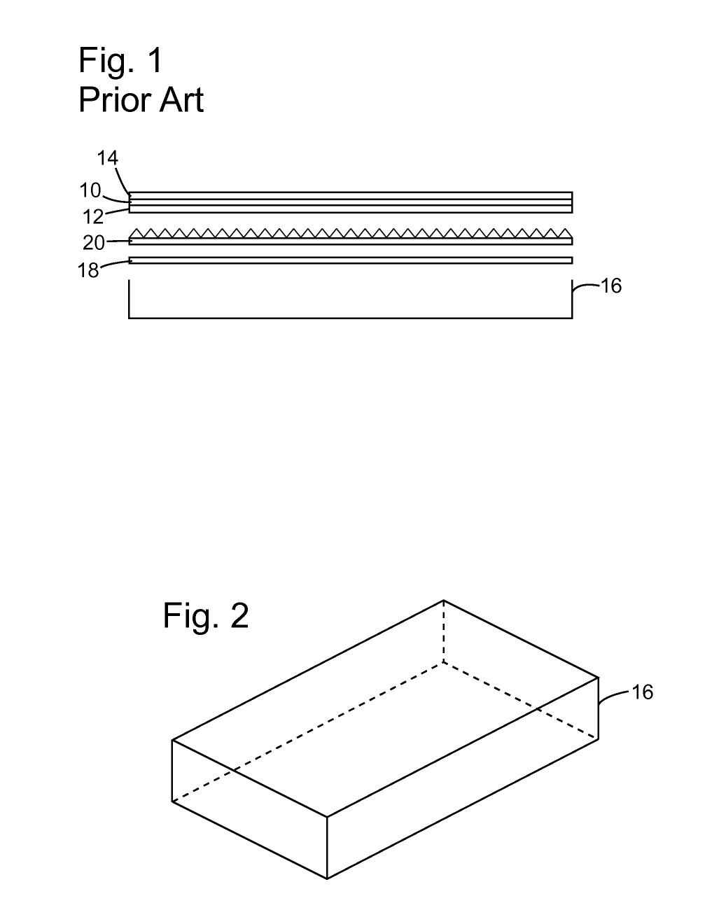

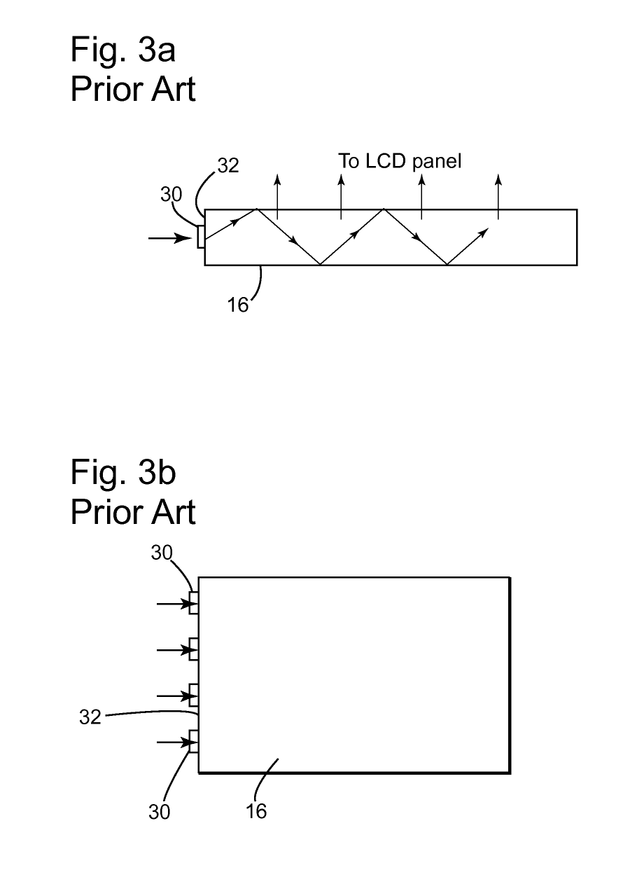

Examples of the polarizers, prismatic layers, diffusers, and light box which may be used are sold by 3M Optical Systems Division. 3M Optical Systems also sells a single film, named collimated multilayer optical film (CMOF), which is the combination of all the required films shown in FIG. 1. With the CMOF product, the LCD display simply consists of an LCD panel laminated with the CMOF film and a light box.

The present invention may be employed with the CMOF product, using fewer LEDs and, in the extreme, a single LED, while still producing a uniform back light output to the LCD display panel.

The foregoing description represents the preferred embodiments of the invention. Various modifications will be apparent to persons skilled in the art. All such modifications and variations are intended to be within the scope of the invention, as set forth in the following claims.

1. A light box for use in a backlight for an LCD monitor, wherein said light box includes an inwardly reflective bottom and sides and an open top for allowing light to flow outwardly, said light box including a light source comprising at least one LED element for generating light either from said edge or from said bottom, or from both said bottom and said edge, and further comprising at least one wave plate mounted on the reflected bottom or sides for intercepting light and changing the polarity of such intercepted light.

2. The light box of claim 1, wherein said light box includes a plurality of LED elements and a plurality of wave plates.

3. The light box of claim 2, wherein said LED elements provide light through the sides of the light box.

4. The light box of claim 3, comprising a plurality of wave plates interspersed with said LED elements.

5. The light box of claim 4, wherein the wave plates are quarter wave plates.

6. The light box of claim 2, wherein said LED elements provide light through the bottom of the light box.

7. The light box of claim 6, comprising a plurality of wave plates interspersed with said LED elements.

8. The light box of claim 7, wherein the wave plates are quarter wave plates.

9. An LCD monitor comprising an LCD panel and a backlight for providing illumination to said LCD panel, wherein said backlight includes a light box having an inwardly reflective bottom and sides and an open top for allowing light to flow outwardly toward said LCD panel, said light box including a light source comprising at least one LED element for generating light either from said edge or from said bottom, or from both said bottom and said edge, and further comprising at least one wave plate mounted on the reflected bottom or sides for intercepting light and changing the polarity of such intercepted light.

10. The LCD monitor of claim 9, wherein said light box includes a plurality of LED elements and a plurality of wave plates.

11. The LCD monitor of claim 10, wherein said LED elements provide light through the sides of the light box.

12. The LCD monitor of claim 11, comprising a plurality of wave plates interspersed with said LED elements.

13. The light box of claim 12, wherein the wave plates are quarter wave plates

14. The LCD monitor of claim 10, wherein said LED elements provide light through the bottom of the light box.

15. The LCD monitor of claim 14, comprising a plurality of wave plates interspersed with said LED elements.

16. The LCD monitor of claim 15, wherein the wave plates are quarter wave plates.

17. The LCD monitor of claim 15, wherein said backlight includes a polarizer for transmitting light from said light box of a first polarization towards said LCD panel and reflecting light of a second polarization back towards said light box, wherein at least some of the reflected light of the second polarization is converted to the first polarization by the wave plates and reflected back towards said polarizer, the wave plates thereby acting as secondary light sources.
